(19) United States
(12) Patent Application Publication
(10) Pub. No.: US 2004/0236605 A1
(43) Pub. Date: Nov. 25, 2004

(54) System and method for management of health care services

(76) Inventor: Pitambar Somani, Dublin, OH (US)

Correspondence Address: Porter, Wright, Morris & Arthur LLP, ATTN: Intellectual Property Department, 28th Floor, 41 South High Street, Columbus, OH, 43215-6194, US

(21) Appl. No.: 10/815,554

(22) Filed: Apr. 1, 2004

Related U.S. Application Data
(60) Provisional application No. 60/459,400, filed on Apr. 1, 2003.

(51) Int. Cl. G06F 17/60

(52) U.S. Cl. 705/2; 705/39

(57) ABSTRACT

A method for management of health care services includes obtaining first, second, and third individual accounts for a participant at a financial institution, obtaining high deductible health insurance for the participant, predetermining authorized health care services, and predetermining authorized preventive health care services. A first portion of a premium of the participant is deposited in the first account for obtaining the high deductible health insurance. A second portion of the premium is deposited in the second account which is a savings account for obtaining the authorized health care services. A third portion of the premium is deposited in the third account for obtaining the authorized preventive health care services. A debit card provides the participant with access the second and third accounts to make direct payments for the authorized health care services and the authorized preventive health care services.

### CROSS-REFERENCE TO RELATED APPLICATIONS

This application claims benefit of U.S. provisional patent application No. 60/459,400 filed on Apr. 1, 2003, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a system and method for management of health care services and, more particularly, to such a system and method which establishes a plurality of accounts for each participant from which the participant can utilize a debit card to obtain health care services and eliminate billing.

### BACKGROUND OF THE INVENTION

Every organization, whether in public sector or in private sector, is concerned about escalating health care costs including rising premiums with double digit annual increases with no relief in sight.

Managed care tried to reign in such costs, and after several years of some stabilization in health insurance premiums, we are back to the same situation as in the last decade. Both private and public sectors (state and local governments; Medicaid and Medicare programs) are affected. Soaring health care costs are posing challenges to both management and labor leaders.

Everyone is asking the same question once again: is there anything we can do to control health care costs and expenditure?

The reality is that ultimately the employee (that's us), not the employer, and taxpayers (that's us too), not the government, are paying the bill. It may not directly come out of our pockets, but it's the money that someone is paying on our behalf to the insurance companies or the health care providers (doctors, hospitals, pharmacies etc.). It's our money, we have given up control to someone else, and we should take charge of those dollars once more.

The average premium per family per year is already about $9,000 and you may ask what exactly are we buying with this money. We also have no control over how these dollars are spent.

While we have made tremendous advances in technology in the medical and health care field, the current system operates as if we still are in the paper and pencil era of the twentieth century. There is time consuming waste and inefficiencies. There is too much unnecessary paperwork and layer of bureaucracies. All of this is highly non-productive and such inefficiencies are costing us billions of dollars each year.

Escalating costs of health insurance premiums makes it even more difficult to persuade people in the age group of 18 to 44, self-employed or those with incomes below 200% poverty level to become insured. Basically, they don't see any benefit of paying all the money for health insurance premiums and have nothing to show for it at the end of the year.

What options do we have to address the current health care insurance crisis? One option is to continue the status quo. We can continue the status quo by continuing to give money to the insurance companies. However, providers keep demanding higher payments for their services, the insurance companies raise their premiums, and the cycle keeps repeating each year. The costs continue to increase. A second option is to make minor adjustments to keep up with escalating premiums (the most common is to pass on as much cost as possible to the employees: the classic example of cost shifting). A third option is develop innovative new ideas.

The key to success depends upon American ingenuity: cost-effectiveness. Increased productivity and efficiency has been the cornerstone of American business success. Can increased productivity be achieved in the health care arena? It is possible, except we must be sure not to alter the doctor-patient relationship. Patients deserve a reasonable time with their doctors for the payments they are making. Already, we are seeing physician-extenders to help increase productivity, but these physician-extenders can't be the answer.

Any successful solution must also re-examine the negative impact of unfunded mandates and unnecessary paperwork imposed in the health care system. No sincere effort has been made to document the real benefit of such mandates in the name of improved quality or outcomes. Each doctor spends about 2.5 hours daily to address much paperwork, phone calls, etc. In the first meeting of the Ohio House Insurance Committee hearings on March 4^{th}, 2003, Ms. Kelly McGiven, CEO of the Ohio Association of Health Plans testified that nearly a quarter of the health insurance premiums go towards paperwork (processing claims, consumer issues and government mandates). Twenty-five percent of the current national health expenditure of about 1.29 trillion dollars is approximately 322.5 billion dollars that can be reduced by increasing efficiency and productivity. Accordingly, there is clearly a need for an improved system and method for management of health care services.

### SUMMARY OF THE INVENTION

The present invention provides a system and method for management of health care goods and services which overcomes at least some of the above-noted problems of the related art. According to the present invention, a method for management of health care services includes, in combination, the steps of obtaining a plurality of individual accounts for a participant at a financial institution, depositing at least a portion of a premium of the participant in each of their individual accounts, predetermining authorized health care services, and providing a debit card to the participant to access money in their individual accounts to make payments for the authorized health care services.

According to another aspect of the present invention, a method for management of health care services includes, in combination, the steps of obtaining first, second, and third individual accounts for a participant at a financial institution, obtaining high deductible health insurance for the participant, predetermining authorized health care services, and predetermining authorized preventive health care services. A first portion of a premium of the participant is deposited in the first account for obtaining the high deductible health insurance. A second portion of the premium of the participant is deposited in the second account which is a savings account for obtaining the authorized health care services. A third portion of the premium of the participant is deposited in the third account for obtaining the authorized preventive health care services. A debit card is provided to the participant to access money in the second and third accounts to make payments for the authorized health care services and the authorized preventive health care services.

According to another aspect of the present invention, a method for management of health care services includes, in combination, the steps of obtaining first, second, and third individual accounts for a participant at a financial institution, obtaining high deductible health insurance for the participant, predetermining authorized health care services, and predetermining authorized preventive health care services. A first portion of a premium of the participant is deposited in the first account for obtaining the high deductible health insurance. A second portion of the premium of the participant is deposited in the second account which is a savings account for obtaining the authorized health care services. Any remaining funds from a previous annual period in the second account are carried over to the next annual period to discourage the participant from obtaining unneeded health care services. A third portion of the premium of the participant is deposited in the third account for obtaining the authorized preventive health care services. Any remaining funds from a previous annual period in the third account are removed and forfeited by the participant to encourage the participant to obtain preventive health care. A debit card is provided to the participant to access money in the second and third accounts to make payments for the authorized health care services and the authorized preventive health care services. Authorized health care providers which can receive payment by the debit card for the authorized health care services and the authorized preventive health care services are predetermined. Fixed payments are negotiated with the authorized health care providers for the authorized health care services and the authorized preventive health care services.

From the foregoing disclosure and the following more detailed description of various preferred embodiments it will be apparent to those skilled in the art that the present invention provides a significant advance in the technology and art of system for management of health care services. Particularly significant in this regard is the potential the invention affords for providing a high quality, reliable, low cost services. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a chart showing key features of the system for management of healthcare services according to the present invention;

FIG. 2 is a chart showing various accounts established for participants of the system of FIG. 1; and

FIG. 3 is a chart illustrating an example of how the system of FIGS. 1 and 2 can operate.

### DETAILED DESCRIPTION OF CERTAIN PREFERRED EMBODIMENTS

It will be apparent to those skilled in the art, that is, to those who have knowledge or experience in this area of technology, that many uses and variations are possible for the improved system and method for management of health care services disclosed herein. The following detailed discussion of various alternative and preferred embodiments will illustrate the general principles of the invention but other embodiments suitable for other applications will be apparent to those skilled in the art given the benefit of this disclosure.

The present invention is based upon a concept of combining the best possible features of the current system and incorporating new ideas to streamline the process. The present invention gives control of health care dollars to those who are directly involved in the health care.

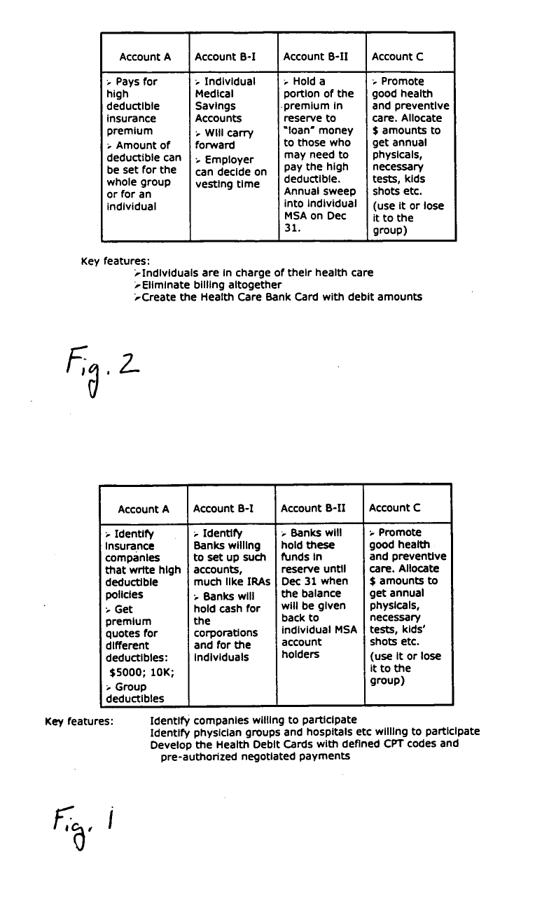

The system preferably includes a plan administrator, at least one health insurance company, at least one financial institution such as a bank, a network of participating health care providers, and participants (individuals, employees of participating companies etc.). As best shown in FIG. 1, the plan administrator identifies insurance companies which write high deductible policies. The administrator can get quotes for different high deductibles such as, for example, $500 to $5,000 or more. The deductibles can be group deductibles. The plan administrator also identifies financial institutions such as banks which can set up a plurality of accounts for each participant and issue Health Debit Cards to access money deposited in at least some of these accounts. The illustrated embodiment utilizes three accounts (Account A, Account B, and Account C) as discussed in more detail hereinbelow. It should be appreciated that other quantities of individual accounts can be utilized within the scope of the present invention. The plan administrator establishes the network of health care providers by identifying physicians, physician groups, hospitals, pharmacies etc. who are willing to participate in the plan. Fixed fee payments are negotiated between the administrator and the health care providers for each service to be provided to the participants. Finally, the administrator must identify companies and/or individuals to participate in the plan.

The Health Debit Cards are provided to the participants to access funds in their individual accounts when obtaining health care services. The Health Debit Cards preferably include information which identifies the participant, pre-authorized goods and services by standard codes such as, for example, Current Procedural Terminology (CPT) codes, International Classification of Disease Ninth (ICD9) codes, or similar codes, pre-authorized negotiated payments for authorized goods and services, and/or any other desirable information such as the requirement of co-pays. The card also preferably includes a photograph of the member. The Health Debit Card preferably stores at least a portion of this information on a magnetic strip so that it can be easily read by swiping through known magnetic strip reading equipment by the health care providers. It should be appreciated, however, that the Health Debit Cards can alternatively store information in other manners such as, for example, by computer memory chips (“smart cards”) or the like. It should also be appreciated that the Health Debit Cards can be utilized in broader applications by public or private insurance companies or third party administrators such as in Medicare, Medicaid, or other private insurance plans to eliminate health care billing.

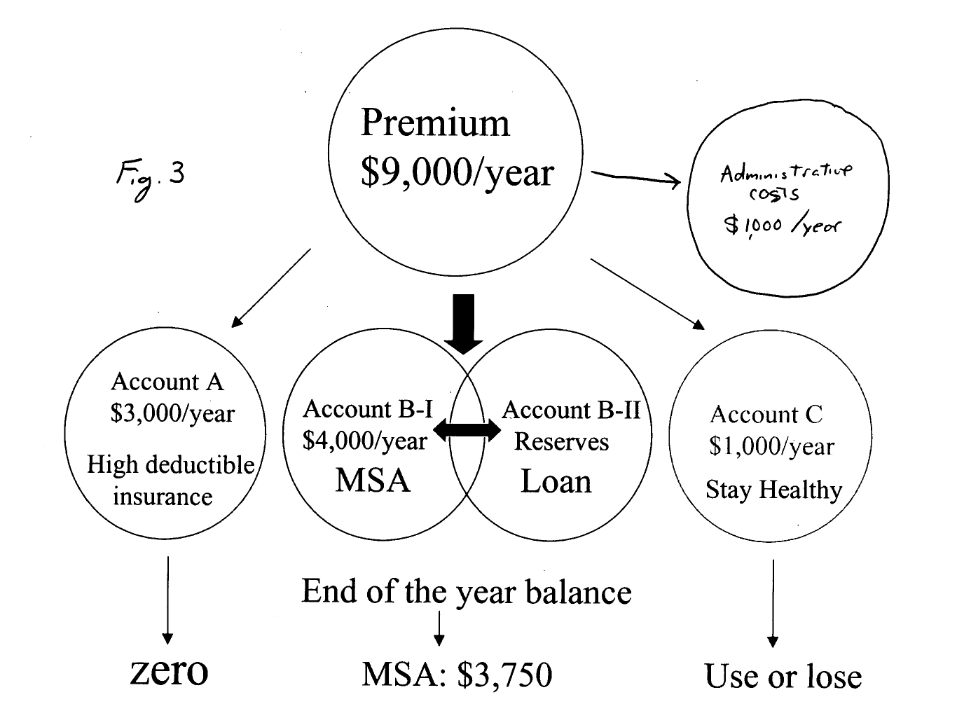

As best shown in FIG. 2, the illustrated plan opens three separate individual accounts at the bank(s) for each participant. The plan inserts a portion of each participant's premiums into their three separate accounts. The first account or Account A is used to pay premiums for high deductible insurance which is obtained from the health insurance company. The amount of deductible for the high deductible insurance can be set for the whole group or for an individual. Preferably, the deductibles are individualized based upon age and risk factors. The amount annually provided in Account A can be, for example, $1000 or more. The second account or Account B has a first portion B-I which is used to establish an individual savings account such as a Medical Savings Account (MSA), a Health Savings Account (HSA), or other suitable individual savings account, and a second portion B-II which is used to hold a portion of the premiums in reserve to loan money the participant to other members who may need to pay high deductibles due to unexpected high medical expenses. The MSA, HSA, or other individual savings account is held by a financial institution such as a bank much like an IRA and will carry forward from year to year. The participating employer(s) decides on vesting time for the participating employees. The loan reserve money is automatically swept into the MSA, HSA or other individual savings account on an annual basis such as at the end of the year. The amount provided annually in Accounts B-I and B-II can be, for example, $1000 or more each. The third account or Account C is used to pay for preventive care to promote good health. The preventive care account allocates a fixed amount of money for preventive care such as annual physicals, kids shots, etc. This fixed amount is used during the year or it is lost to the individual or family participant at the end of the year. This individual account provides strong incentive and assures that the participants go to doctors or other approved health care providers for regular preventive checkups. This account pays for preventative care such as, for example, doctor's fees for physicals, lab tests, x-rays, pap smears, mammograms, etc. Each member may continue to pay usual out of pocket expenses as an individual part of account C. These out-of-pocket expenses may include “co-pays”. The fixed amount of money annually provided in Account C can be, for example about $1000 per family. Each person spends an amount such as $750 to $1000 per year for out of hospital co-pays but there are no extra hassles of collecting and accounting of co-pays in the proposed invention.

The individual participants manage their own individual accounts and are responsible for purchases or debits made with the Heath Debit Card. It is noted, however, that alternatively the participating companies can insure the debits of their employees so that the employers rather than the employees bear the risk of the debits. Under these circumstances the risk to the individual participants is minimal because the employers bear the risk. It is also noted that alternatively the individual accounts can alternatively be managed by the employer rather than the participant/employee.

As best shown in FIG. 3, operation of the plan will be described by way of an example wherein the annual outlay for a family is $9000. It is noted that the annual outlay can be lesser or greater than $9000 and is preferably adjusted for individual participants such as, for example, an annual outlay of $5000 for individuals when the annual outlay is $9000 for families. The present plan can manage the $9000 in the following way. A portion of the annual outlay of $9000, such as approximately $3000, is placed in Account A for payment of premiums for high deductible health insurance. The administrator utilizes the finds in Account A to purchase high deductible health insurance for the participant such as, for example, insurance with a deductible of $5000. A portion of the annual outlay of $9000, such as approximately $3000, is placed in Account B-I for the participant's MSA, HSA, or other individual savings account. A portion of the annual outlay of $9000, such as approximately $1000, is placed in Account B-II as a “loan reserve”. A portion of the annual outlay of $9000, such as approximately $1000, is placed in account C for preventive care. A portion of the annual outlay of $9000, such as approximately $1000, is held aside by the administrator to pay for administrative costs and the like of the plan. It is noted that the various outlay portions and deductibles are by way of example only and can be greater or lesser than the illustrated amounts. It is also noted that while this example illustrates a family account, similar accounts but with different annual deposit amounts are established for individuals.

The participants or members have complete freedom to chose their doctors and other health care providers from the list of participating health care providers provided by the administrator. When a participant visits a participating physician for care, the participating physician or his agent “swipes” the participant's Health Debit Card to determine whether the desired goods and services are pre-authorized and the amount of associated pre-negotiated fees for the desired goods and services. If the goods or services are pre-authorized on the debit card, the physician proceeds. If the desired goods or services are not pre-authorized on the debit card, the physician or his agent must call the administrator or his agent for authorization of the goods or services. This is the managed portion of the plan. If the goods or services are authorized by the administrator or his agent after the call thereto, the physician proceeds. The physician informs the member of costs involved and the member chooses whether to “purchase” the goods and services. If the patient chooses to purchase goods or services, the physician proceeds to deliver appropriate, authorized goods and services.

The physician or his agent forwards, preferably by electronic transmission, the purchase authorization to the bank or financial institution and the member's appropriate individual account is automatically debited by the pre-negotiated amount just as in a typical debit card transaction. Account C is debited if the delivered goods or services were for preventive care. Account B-I is debited if another type of care was delivered or if Account C is depleted. It is noted that the physician does not have to bill the insurance company or send bills or statements to the member in any way. The fixed payment to the physician is automatic, similar to the use of debit cards for other types of goods and services and will be based upon defined CPT or other codes and provider agreements. The entire process of billing and collection, delays, denials, sending account payable statements, etc. that now consumes so much time and money is replaced by a debit card which can be used only in approved health care facilities.

Once the participant meets the deductible, the health insurance pays for any additional goods and services. In this example, the annual deductible is $5000 so the high-deductible health insurance begins to pay all costs as soon as the participant spends $5000. In this example, the annual contributions to Accounts B and C total $5000 which is equal to the deductible so the insurance will begin paying all costs as soon as the participant spends all the annual contributions to Accounts B and C. Of course, the deductible can alternatively be reached in other manners.

The bank issues a periodic statement of the accounts such as, for example, a monthly statement, to both the member and the plan administrator. The member can use this statement to monitor purchases and the balances in their individual accounts. The administrator closely monitors health service utilization and expenses for “big ticket” items (i.e. expensive tests, surgeries, hospital admissions etc.). The patient has the freedom to go to multiple doctors, however, this will be apparent when the administrator gets the monthly statements of their Health Debit Card. The administrator can then educate the member regarding proper use of the Health Debit Card and ultimately revoke the debit card if improper use continues. If a health care provider is providing too many services (over utilization or possible fraud) it will become apparent to the administrator by reviewing the monthly statements. The administrator can then educate the health care provider regarding the delivery of unauthorized goods or services and ultimately revoke the participation of the health care provider if improper or unnecessary goods or service continue to be delivered.

At the end of a reporting period such as, for example, at the end of the year, any remaining funds in Accounts B-I and B-II are carried over to the next period. In the illustrated example, the participant spent only $250 of the allotted $4000 so that $3750 is carried over into the next year. Thus the participant will start the next year with $6750 in Account B-I and $1000 in Account B-II. This encourages the participants to save money by not spending all of the funds during the reporting period so that they accumulate funds year after year until they really need the funds. There should not be any funds remaining in Account A at the end of the reporting period because the amount deposited during the period preferably equals the amounts of the premiums due for the period. If for some reason any funds do remain in Account A they are carried over into the next year. At the same time, any funds which remain in Account C at the end of the reporting period are lost to the individual and go to the group. That is, any funds in Account C which are not used by the participant during the period are lost by that participant and do not carry over to the next reporting period. In this manner (use it or lose it), preventive health care is promoted. The administrator may negotiate the use of the year end balance in Account C for heath care or education purposes or any other desired use.

From the foregoing disclosure and detailed description of certain preferred embodiments, it is apparent that individuals have complete freedom to chose their doctors and other health care providers, the current process of billing and collection is replaced by a debit card which can be used only in approved health care facilities and participating doctor's offices, health care utilization and expenses are closely managed for “big ticket” items, preventive health care is promoted, and participants get to carry-over unspent (saved) funds from year to year until they really need the funds.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by applicable claims when interpreted in accordance with the benefit to which they are fairly, legally, and equitably entitled.

What is claimed is:

1. A method for management of health care services comprising, in combination, the steps of:
obtaining a plurality of individual accounts for a participant at a financial institution;
depositing at least a portion of a premium of the participant in each of their individual accounts;
predetermining authorized health care services; and
providing a debit card to the participant to access money in their individual accounts to make payments for the authorized health care services.

2. The method for management of health care services according to claim 1, further comprising the step of predetermining authorized health care providers which can receive payment by the debit card for the authorized health care services.

3. The method for management of health care services according to claim 2, further comprising the step of negotiating fixed payments with the authorized health care providers for the authorized health care services.

4. The method for management of health care services according to claim 1, further comprising the step of obtaining high deductible health insurance for the participant.

5. The method for management of health care services according to claim 4, further comprising the step of depositing at least a portion of the premium of the participant in one of their individual accounts for obtaining the high deductible health insurance for the participant.

6. The method for management of health care services according to claim 1, further comprising the step of depositing at least a portion of the premium of the participant in one of their individual accounts which is a savings account for obtaining health care services.

7. The method for management of health care services according to claim 6, further comprising the step of carrying over any remaining funds from a previous annual period in the savings account to discourage the participant from obtaining unneeded health care services.

8. The method for management of health care services according to claim 1, further comprising the step of depositing at least a portion of the premium of the participant in one of their individual accounts for loans to the participant and other participants who need to pay extraordinarily high deductibles.

9. The method for management of health care services according to claim 1, further comprising the step of depositing at least a fixed portion of the premium of the participant in one of their individual accounts for payment of authorized preventive health care services.

10. The method for management of health care services according to claim 9, further comprising the step of removing any remaining funds of the fixed portion from a previous annual period to encourage the participant to obtain authorized preventive health care.

11. The method for management of health care services according to claim 1, the plurality of individual accounts includes a first account, a second account, and a third account and further comprising the steps of depositing a first portion of the premium of the participant in the first account for obtaining high deductible health insurance for the participant, depositing a second portion of the premium of the participant in the second account which is a savings account for obtaining health care services, and depositing a third portion of the premium of the participant in the third account for payment of authorized preventive health care services.

12. The method for management of health care services according to claim 11, further comprising the steps of carrying over any remaining funds from a previous annual period in the second account to discourage the participant from obtaining unneeded health care services, and removing any remaining funds from a previous annual period in the third account to encourage the participant to obtain preventive health care.

13. The method for management of health care services according to claim 1, further comprising step of providing identification of the authorized health care services on the debit card.

14. The method for management of health care services according to claim 1, further comprising step of managing any health care services which are not authorized health care services.

15. A method for management of health care services comprising, in combination, the steps of:
obtaining first, second, and third individual accounts for a participant at a financial institution;
obtaining high deductible health insurance for the participant;
predetermining authorized health care services;
predetermining authorized preventive health care services;
depositing a first portion of a premium of the participant in the first account for obtaining the high deductible health insurance;
depositing a second portion of the premium of the participant in the second account which is a savings account for obtaining the authorized health care services;
depositing a third portion of the premium of the participant in the third account for obtaining the authorized preventive health care services; and
providing a debit card to the participant to access money in the second and third accounts to make payments for the authorized health care services and the authorized preventive health care services.

16. The method for management of health care services according to claim 15, further comprising the step of predetermining authorized health care providers which can receive payment by the debit card for the authorized health care services and the authorized preventive health care services.

17. The method for management of health care services according to claim 16, further comprising the step of negotiating fixed payments with the authorized health care providers for the authorized health care services.

18. The method for management of health care services according to claim 15, further comprising the step of carrying over any remaining funds from a previous annual period in the second account to discourage the participant from obtaining unneeded health care services.

19. The method for management of health care services according to claim 15, further comprising the step of removing any remaining funds from a previous annual period in the third account to encourage the participant to obtain preventive health care.

20. The method for management of health care services according to claim 15, wherein the second account has first and second portions, wherein the first portion of the second account is the savings account for obtaining the authorized health care services, and further comprising the step of depositing at a fourth portion of the premium of the participant in the second portion of the second account for loans to the participant and other participants who need to pay extraordinarily high deductibles.

21. The method for management of health care services according to claim 15, further comprising step of providing identification of the authorized health care services on the debit card.

22. The method for management of health care services according to claim 15, further comprising step of managing any health care services which are not authorized health care services and authorized preventive health care services.

23. A method for management of health care services comprising, in combination, the steps of:
obtaining first, second, and third individual accounts for a participant at a financial institution;
obtaining high deductible health insurance for the participant;
predetermining authorized health care services;
predetermining authorized preventive health care services;
depositing a first portion of a premium of the participant in the first account for obtaining the high deductible health insurance;
depositing a second portion of the premium of the participant in the second account which is a savings account for obtaining the authorized health care services;
carrying over any remaining finds from a previous annual period in the second account to discourage the participant from obtaining unneeded health care services;
depositing a third portion of the premium of the participant in the third account for obtaining the authorized preventive health care services;
removing any remaining funds from a previous annual period in the third account to encourage the participant to obtain preventive health care;
providing a debit card to the participant to access money in the second and third accounts to make payments for the authorized health care services and the authorized preventive health care services;
predetermining authorized health care providers which can receive payment by the debit card for the authorized health care services and the authorized preventive health care services; and
negotiating fixed payments with the authorized health care providers for the authorized health care services and the authorized preventive health care services.

24. The method for management of health care services according to claim 23, wherein the second account has first and second portions, wherein the first portion of the second account is the savings account for obtaining the authorized health care services, and further comprising the step of depositing at a fourth portion of the premium of the participant in the second portion of the second account for loans to the participant and other participants who need to pay extraordinarily high deductibles.

25. The method for management of health care services according to claim 23, further comprising step of providing identification of the authorized health care services on the debit card.

26. The method for management of health care services according to claim 23, further comprising step of managing any health care services which are not authorized health care services.
